(19) United States
(12) Patent Application Publication
(10) Pub. No.: US 2007/0137624 A1
(43) Pub. Date: Jun. 21, 2007

(54) Energy saving device for generators

(76) Inventor: Wen-Ching Lee, Taipei (TW)

Correspondence Address: Wen-Ching Lee, P.O. Box 96-556, Taipei, 10668, TW

(21) Appl. No.: 11/300,459

(22) Filed: Dec. 15, 2005

(51) Int. Cl. F02M 27/00

(52) U.S. Cl. 123/539

(57) ABSTRACT

An energy saving device for generators includes an ion generation device which has a first end thereof connected to an ion discharge line and a second end of the ion generation device is connected with a power source. The ion discharge line can be installed in the air-filtering fore pipe, the air filter, the air-filtering rear pipe, the mixing chamber, the fuel injection pipe, the main body, or the air pipe of the generator. The energy saving device improves the quality of mixture of the fuel and air so that the efficiency of the combustion is increased.

### BACKGROUND OF THE INVENTION

(1) Field of the Invention

The present invention relates to a energy saving device for improving the mixture of fuel and air to save energy of generators.

(2) Description of the Prior Arts

Modern industrial society requires a huge amount of energy everyday on airplanes, vehicles or generators. However, the fuel such as petroleum is limited and the source of the petroleum is difficult to find so that it is important to increase the efficiency of combustion by improving the mixture of the fuel and air. If the mixture of the fuel and the air is not done properly before entering the engine, the combustion is not completed and pollutants are generated. Although there are many methods have been developed to improve the mixing of the fuel and air, it is believed that there have other ways to further improve the mixture of the fuel and air.

The present invention intends to provide an energy saving device by using ion generation device to ionize the air which is mixed with fuel and the ionized air is improved to increase the efficiency of combustion.

### SUMMARY OF THE INVENTION

The present invention relates to an energy saving device for generators and the device includes an ion generation device which is connected between an ion discharge line and a power source. The ion discharge line is installed in the air-filtering fore pipe, the air filter, the air-filtering rear pipe, the mixing chamber, the fuel injection pipe, the main body, or the air pipe of the generator.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the mixing of fuel and air, combustion and exhaust air outgoing of the positions where the ion discharge line is installed;

FIG. 2 shows the connection of the ion discharge line, the ion generation device and the generator;

FIG. 3 shows the connection between the power source and the ion generation device;

FIG. 4 shows the connection between the power source and the ion generation device with an earth line;

FIG. 5 shows the ion generation device, and

FIG. 6 shows the structure of the ion generation device.

### DETAILED DESCRIPTION OF THE PREFERRED EMBODIMENT

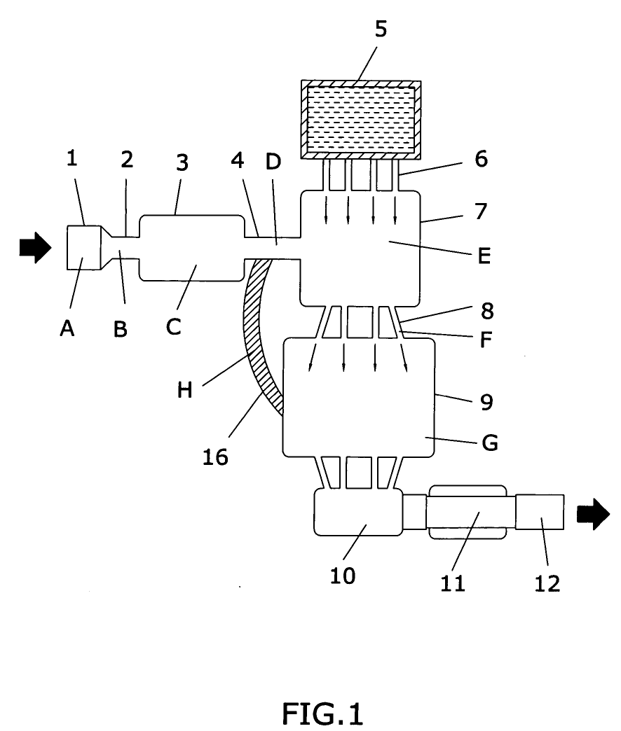

Referring to FIG. 1, a generator includes an inlet 1, an air-filtering fore pipe 2, an air filter 3, and an air-filtering rear pipe 4, these parts are connected in sequence and are connected to a mixing chamber 7 for mixing the fuel and air. A fuel injection orifice 6 is located at a side of the mixing chamber 7 and connected to the fuel tank 5. A fuel injection pipe 8 is connected to the other end of the mixing chamber 7 and in communication with the combustion chamber of the main body 9 of the generator. The combustion chamber is connected with an exhaust air collection area 10, a muffler 11 and an exhaust air pipe 12.

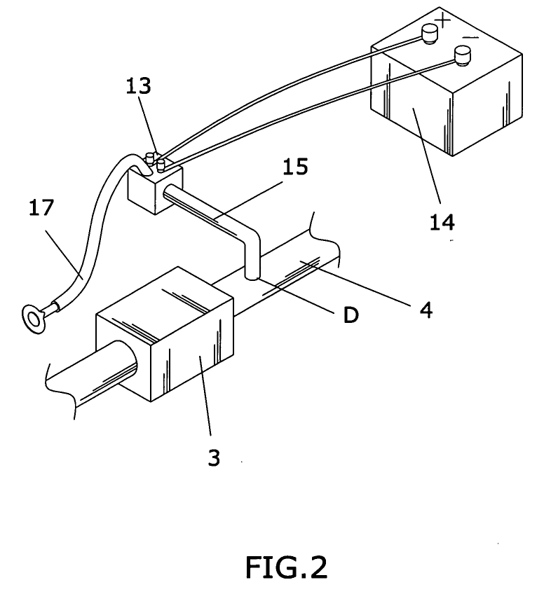

Point “A” discloses the position where the ion discharge line 15 is installed in the inlet 1 and point “B” is the position where the ion discharge line 15 is installed in the air-filtering fore pipe 2. Point “C” discloses the position where the ion discharge line 15 is installed in the air filter 3 and point “D” is the position where the ion discharge line 15 is installed in the air-filtering rear pipe 4, as shown in FIG. 2.

Point “E” discloses the position where the ion discharge line 15 is installed in the mixing chamber 7 and point “F” is the position where the ion discharge line 15 is installed in the fuel injection pipe 8. Point “G” discloses the position where the ion discharge line 15 is installed in the main body 9 and point “H” is the position where the ion discharge line 15 is installed in the air pipe 16. At least one point of the above mentioned seven points has an ion discharge line 15 installed therein and the other end of the ion discharge line 15 is connected with the ion generation device 13 which is connected to the power source 14. It is noted that the ion discharge line 15 can be installed to one or more than one points in the generator. The ion discharge line 15 has to be connected with the ion generation device 13 and the power source 14.

As shown in FIG. 2, the ion generation device 13 is connected between the power source 14 and the ion discharge line 15 and is installed in the “D” point in the air-filtering rear pipe 4. The ion discharge line 15 generally is a high voltage line. The ion generation device 13 is a negative ion generation device or a plasma generation device. The negative ion generation device or the plasma generation device can be used in either in either A, B, C, D, E, F or G point so that ions can be maintained in the air for a longer period of time and the vivid nature of the ions improves the mixture of the fuel and air.

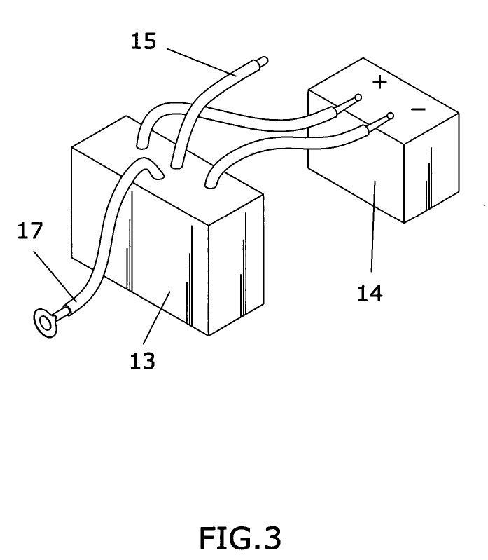

As shown in FIG. 3, the ion generation device 13 is a negative ion generation device and the ion discharge line 15 releases negative ions. The earth line 17 is in contact with a metallic part in the generator so as to remove the static electricity.

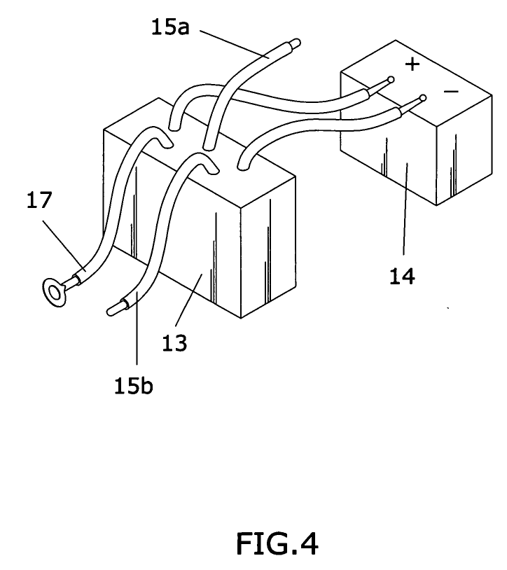

As shown in FIG. 4, the ion generation device 13 is a plasma generation device and there are two ion discharge lines 15a and 15b, wherein the ion discharge line 15a releases positive ions and the ion discharge line 15b releases negative ions.

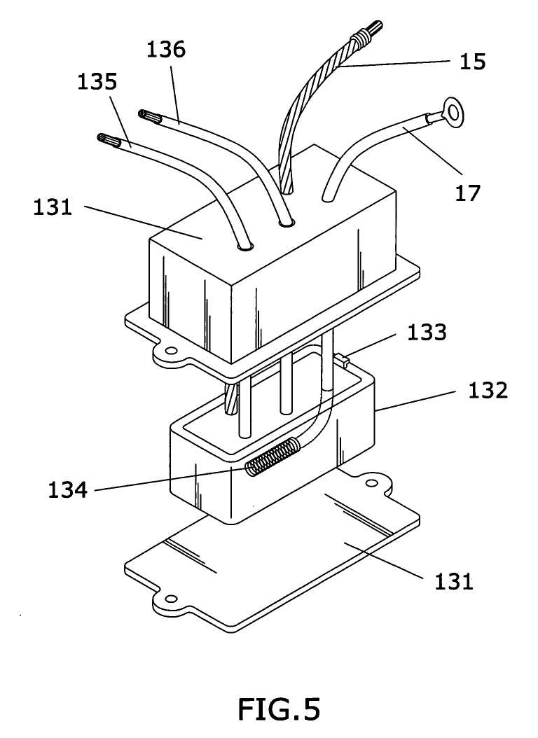

FIG. 5 is an exploded view to show the negative ion generation device 13 with which two power lines 135, 136 are connected. The two power source lines 135, 136 are connected to the power source of a vehicle. The ion discharge line 15 releases ions at the installation points and the vibration voltage transformer 134 is connected with the earth line 17. The metal earth plate 133 is in contact with the metallic casing 131 which is connected with the earth line 17 which is connected to a metallic part of the generator so as to form a circuit to prevent interruption by static electricity.

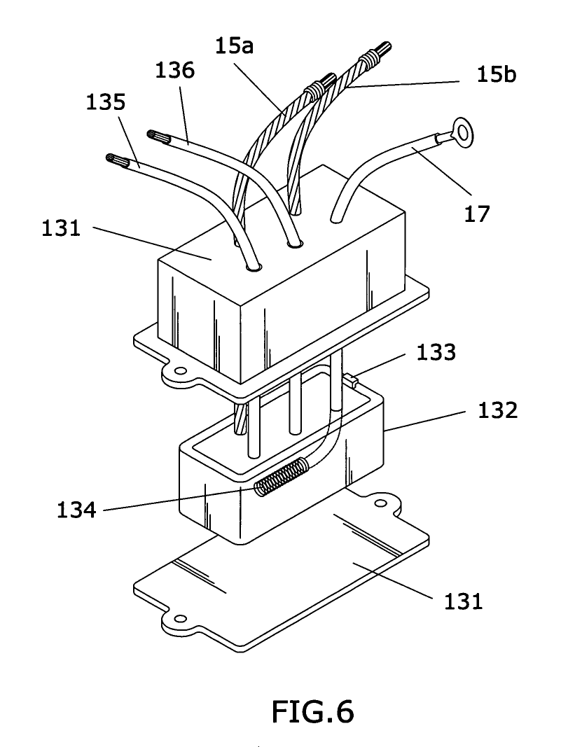

FIG. 6 is an exploded view to show the plasma generation device 13 with which two power lines 135, 136 are connected. The two power source lines 135,136 are connected to the power source of a vehicle. The ion discharge line 15 releases ions at the installation points and the vibration voltage transformer 134 is connected with the earth line 17. The metal earth plate 133 is in contact with the metallic casing 131 which is connected with the earth line 17 which is connected to a metallic part of the generator so as to form a circuit to prevent interruption by static electricity.

The present invention includes the following advantages:

1. The internal combustion machine and the ion generation devices are well developed and the ion generation devices occupy less space than the internal combustion machine. It is not difficult to connect the internal combustion machine and ion generation devices.

2. The ion generation device is connected with power source and releases ions via the ion discharge lines which can be easily installed in the inlet, the air-filtering fore pipe, the air filter, the air-filtering rear pipe, the mixing chamber, the fuel injection pipe, the main body, and the air pipe.

3. The power source generates a high voltage in the ion generation device and the ions are released into the generator by the ion discharge lines. The ions ionizes the air into molecules, ions, electrons and active free radicals. The ionized air is also the plasma air stream which improves the efficiency of combustion and reduces the generation of hydro-carbon combination.

4. When the positive or the negative ions are released in the generator, the binding energy of the hydro-carbon is released and the carbon and hydrogen are separated which are active and can be easily combined with oxygen in the air so that the results of combustion can be simplified to be water and the carbon-dioxide. The efficiency of combustion is improved and the fuel required for a certain mileage can be reduced.

5. A 1300 c.c. vehicle engine is taken to run 77 km at speed of 90 km/hr and obtains the following results, wherein carbon monoxide is 0.4%, hydro-carbon gas is 177 P.P.M., fuel consumption is 9.15 km per liter. On the contrary, a 1300 c.c. vehicle engine installed with the energy saving device is taken to run 77 km and obtains the following results, wherein carbon monoxide is zero(reduced 100%), hydrocarbon gas is below 10 P.P.M.(reduced 94.35%), fuel consumption is 13.75 km per liter(save 30-33%).

There are four different engines are tested under the same conditions as the engine with the energy saving device of the present invention, different results are obtained. A 1300 c.c. Japanese vehicle engine with a COX energy saving device by using electro-magnetic wave to ionize the air is taken to run 77 km at speed of 90 km/hr and obtains the following results, wherein carbon monoxide is 0.1%, hydro-carbon gas is 59 P.P.M., fuel consumption is 9.49 km per liter. A 1300 c.c. vehicle engine made in China with a Green Power energy saving device by using electro-magnetic wave to ionize the air is taken to run 77 km at speed of 90 km/hr and obtains the following results, wherein carbon monoxide is 0.2%, hydrocarbon gas is 151 P.P.M., fuel consumption is 10.39 km per liter. A 1300 c.c. vehicle engine made in China with an ozone energy saving device by using electromagnetic wave to ionize the air is taken to run 77 km at speed of 90 km/hr and obtains the following results, wherein carbon monoxide is 0%, hydrocarbon gas is 35 P.P.M., fuel consumption is 11.4 km per liter. All of the engines do not find corrosion in the parts of the engines, except for the engine using ozone energy saving device which causes corrosion on plastic pipes.

While we have shown and described the embodiment in accordance with the present invention, it should be clear to those skilled in the art that further embodiments may be made without departing from the scope of the present invention.

What is claimed is:

1. An energy saving device for generators which include an inlet, an air-filtering fore pipe, an air filter, an air-filtering rear pipe, a mixing chamber, a fuel injection pipe, a main body and an air pipe, the energy saving device comprising:
an ion generation device having a first end thereof connected to an ion discharge line and a second end of the ion generation device connected with a power source.

2. The device as claimed in claim 1, wherein the ion generation device is a negative ion generation device.

3. The device as claimed in claim 1, wherein the ion generation device is a plasma generation device.

4. The device as claimed in claim 1 further comprising an earth line which is adapted to be connected to a metallic part of the generator.

5. The device as claimed in claim 1, wherein the ion generation device has a metallic casing.

6. The device as claimed in claim 1, wherein the ion generation device has a metal earth plate which is in contact with a metallic casing of the ion generation device.
